(19) United States
(12) Patent Application Publication
(10) Pub. No.: US 2025/0246377 A1
(43) Pub. Date: Jul. 31, 2025

(54) ELECTRIC CURRENT SWITCHING DEVICE

(71) Applicant: Schneider Electric Industries SAS, Rueil Malmaison (FR)

(72) Inventors: Jules Perbet, Chonas I'Amballan (FR); Florian Beaup, Saint Martin d'Uriage (FR)

(73) Assignee: Schneider Electric Industries SAS, Rueil Malmaison (FR)

(21) Appl. No.: 19/040,148

(22) Filed: Jan. 29, 2025

(30) Foreign Application Priority Data
Jan. 31, 2024 (FR) 2400973

(51) Int. Cl. H01H 1/58; H01H 1/04

(52) U.S. Cl. CPC H01H 1/58; H01H 1/04

(57) ABSTRACT

An electric current switching device including: a first line portion including a first electrical conductor and a fixed contact secured to the first conductor; and a second line portion including a second electrical conductor and a movable contact in rotation configured to be moved between: an open position preventing the passage of current, and a closed position allowing the passage of current. The movable contact extends, in the closed position, in a direction transverse to a direction of extension of the first electrical conductor. The fixed contact includes a first portion configured to be in contact with the movable contact and a second portion fixed to the first electrical conductor, wherein the first portion and the second portion are offset in the direction of extension of the first electrical conductor.

### TECHNICAL FIELD

The present invention relates to the field of electrical unit switching devices for medium voltage, namely voltages from 1 to 52 kV. These switching devices enable the circulation of current in an electrical network of medium-voltage type to be switched off or on.

### PRIOR ART

The switches used in medium voltage electrical networks may comprise at least a fixed contact and a mobile contact movable in rotation between at least two positions. One of the positions corresponds to a position in which the fixed contact and the mobile contact are separated, and is referred to as the open position in which the flow of current is interrupted. One of the positions corresponds to a position in which the fixed contact and the mobile contact are in mechanical and electrical contact, and is referred to as the closed position that allows current to pass through the circuit.

The mobile contact may be moved alternately from one position to the other, by means of a control mechanism. Such a switch is installed on each of the phases of the electrical network.

Certain switches have three positions, the third position corresponding to an earthing of a portion of the circuit.

When the ability for the electrical current to pass is established, namely when the switch moves from the open-circuit position to the closed position, the current strength may be particularly high when there is a short circuit in the circuit that is to be connected. A short-circuit may also occur when the switch is already in the closed position. The strength of the short-circuit current may exceed 50,000 amps for a period lasting a few tens of milliseconds, until a protective unit installed upstream of the switch opens the electrical circuit. The electrodynamic forces generated by such a short-circuit current generally tend to cause the mobile contact to reopen. Such reopening is to be avoided, because of the risk of damage due to the electrical arcs created.

There is still a need to obtain switches for which the risk of reopening upon short-circuiting is eliminated or at least reduced.

### SUMMARY

To this end, the invention proposes an electric current switching device, comprising:
a first electrical line portion comprising a first electrical conductor and a fixed contact secured to the first electrical conductor,
a second electrical line portion comprising a second electrical conductor and a mobile contact movable in rotation relative to the second electrical conductor, the mobile contact being configured to be moved between:
a first position referred to as an open position in which the mobile contact is separated from the fixed contact so as to prevent the passage of electrical current between the first electrical line portion and the second electrical line portion, and
a second position referred to as a closed position in which the mobile contact is in contact with the fixed contact so as to allow electrical current to pass between the first electrical line portion and the second electrical line portion,
wherein the mobile contact extends, in the second position, in a direction transverse to a direction of extension of the first electrical conductor,
wherein the fixed contact comprises a first portion configured to be in contact with the mobile contact and a second portion fixed to the first electrical conductor,
and wherein the first portion and the second portion are offset from one another in the direction of extension of the first electrical conductor.

The mutual offsetting of the first portion, through which the electrical current arrives at the fixed contact, and the second portion, through which the electrical current leaves the fixed contact, makes it possible to soften the change in direction of the electrical current. The electrodynamic forces that have a tendency to open the mobile contact, notably when a circuit current is circulating through the electrical line, are thus reduced. The capacity of the switching device is increased.

The features listed in the following paragraphs may be implemented independently of one another or in any technically possible combination:

At least part of the first portion is separated from the first electrical conductor by a portion devoid of material.

At least part of the first portion is separated from the first electrical conductor by a gas void.

The gas is the gas surrounding the switch. The gas may for example be air or some other gas having good electrical insulation properties.

The first portion and the second portion partially overlap in the direction of extension of the first electrical conductor.

According to one embodiment of the electric current switching device, the first portion of the fixed contact faces an end portion of the first electrical conductor.

According to one aspect of the electric current switching device, the fixed contact comprises a bearing face configured to be in contact with the first electrical conductor, and the first portion is connected to the bearing face by a portion of material having a concave shape.

In other words, certain straight-line segments joining the first portion to the bearing face are not contained inside the volume delimited by the exterior surface of the fixed contact.

The first electrical conductor comprises, for example, an electric current conductor rod.

Likewise, the second electrical conductor comprises, for example, an electric current conductor rod.

The first electrical conductor is secured to a frame.

The second electrical conductor is secured to the frame.

The first electrical conductor is for example formed by a rod, for example a copper rod. Likewise, the second electrical conductor may be formed by a copper rod.

Each rod may have a cross section of rectangular shape.

The fixed contact is rigidly connected to the frame.

The mobile contact is movable in rotation with respect to the frame.

According to one exemplary embodiment, the mobile contact has the form of a rod, for example a rectilinear rod.

According to one embodiment, the mobile contact is articulated at a first end. At its second end opposite to the first end the mobile contact comprises a contact zone. The contact zone is configured to establish electrical contact with the fixed contact of the first electrical conductor when the mobile contact is in the second position referred to as a closed position.

In this embodiment, the mobile contact establishes permanent electrical contact with the second electrical conductor at the articulation.

According to another embodiment, the mobile contact is articulated at a middle part situated between the first end and the second end.

The mobile contact comprises, at a first end, a first contact zone configured to establish electrical contact with the fixed contact of the first electrical conductor when the mobile contact is in the second position referred to as a closed position.

The mobile contact comprises, at its second end, a second contact zone configured to establish electrical contact with the second electrical conductor when the mobile contact is in the second position referred to as a closed position.

In other words, in this embodiment, the second electrical conductor itself comprises a fixed contact that can be selectively separated from the mobile contact or engaged with the mobile contact.

Rotating the mobile contact makes it possible to establish mechanical and electrical contact between the mobile contact and each of the first and second electrical conductors.

In the first position referred to as an open position, the mobile contact is separated from the fixed contact of the first electrical conductor and from the fixed contact of the second electrical conductor.

According to one embodiment of the electric current switching device, the mobile contact comprises two electrically conducting and mechanically connecting blades, the two blades being parallel to one another and distant from one another, and the fixed contact is in contact with each of the blades when the mobile contact is in the second position.

The first portion is positioned between the blades when the mobile contact is in the second position.

According to one embodiment of the electric current switching device, in which the fixed contact comprises a bearing face configured to be in contact with the first electrical conductor,
a distance between an end of the first portion of the fixed contact, directed away from the bearing face in an axial direction, and an end of the bearing face situated facing the first portion, the distance being measured parallel to the main direction of extension of the bearing face, is comprised between 50% and 100% of a length of the first portion, the length being measured parallel to a direction of extension of the first portion.

According to one embodiment of the electric current switching device, in which the fixed contact comprises a bearing face configured to be in contact with the first electrical conductor,
a distance between an end of the first portion of the fixed contact, opposed to the bearing face in an axial direction, and an end of the bearing face situated facing the first portion, the distance being measured parallel to the main direction of extension of the bearing face, is comprised between 100% and 300% of a distance between the first portion and the bearing face, the distance being measured parallel to a direction perpendicular to the bearing face.

These values of offset make it possible to reduce the electrodynamic forces on the mobile contact while at the same time keeping the mechanical strength of the fixed contact sufficiently high.

According to one embodiment of the electric current switching device, the fixed contact comprises:
a first part of parallelepipedal overall shape, comprising a bearing face configured to be in contact with the first electrical conductor,
a second part of cylindrical overall shape extending the first part in a direction perpendicular to the bearing face,
the second part being offset from the bearing face in a main direction of extension of the bearing face,
and the first portion of the fixed contact is formed by a portion of a peripheral surface of the second part.

The main direction of extension of the bearing face and the axis of the second part are parallel.

The main direction of extension of the bearing face and the axis of the second part define a plane perpendicular to the axis of rotation of the mobile contact.

According to one embodiment of the electric current switching device, the second part of the fixed contact is extended, in an axial direction, by a third part that is inclined towards the first part of the fixed contact.

The inclined part of the fixed contact plays a part in reducing the electrodynamic forces on the mobile contact, and thus in further reducing the tendency of the contacts to separate, notably in the event of a short-circuit.

According to one exemplary embodiment of the electric current switching device, in cross section on a plane passing through the main direction of extension of the bearing face and perpendicular to the bearing face, an exterior periphery of the third part makes an angle of between 30° and 50° with a direction of extension of the second part.

According to one exemplary embodiment of the electric current switching device, an end of the second part of the fixed contact, opposed to the first part in an axial direction, has a substantially hemispherical shape.

According to one embodiment of the electric current switching device, a distance between an end of the second part of the fixed contact, opposed to the first part in an axial direction, and an end of the first part of the fixed contact, which is situated facing the second part, the distance being measured parallel to the main direction of extension of the bearing face, is comprised between 50% and 100% of a length of the second part of the fixed contact, the length being measured parallel to the axis of extension of the second part.

According to one embodiment of the electric current switching device, a distance between an end of the second part of the fixed contact, opposed to the first part in an axial direction, and an end of the first part of the fixed contact, which is situated facing the second part, the distance being measured parallel to the main direction of extension of the bearing face, is comprised between 50% and 100% of a length of the bearing face of the first part of the fixed contact, the length being measured parallel to the main direction of extension of the bearing face.

According to one embodiment, a length of the third part is comprised between 5% and 100% of a length of the bearing face of the first part of the fixed contact, the length of the third part and the length of the bearing face being measured parallel to the main direction of extension of the bearing face.

According to one embodiment of the electric current switching device, a distance between a proximal edge of the second part of the fixed contact, facing toward the bearing face, and the bearing face, the distance being measured in a direction perpendicular to the bearing face, is comprised between 20% and 100% of a length of the second part of the fixed contact, the length being measured parallel to the axis of extension of the second part.

The fixed contact forms, for example, a one-piece entity.

The fixed contact is for example made of copper.

The first part comprises two threaded bores opening into the bearing face, each threaded bore being configured to accept a respective fixing screw for fixing to the first electrical conductor.

According to one embodiment, the electric current switching device comprises a magnetically conducting insert arranged in part between the first electrical conductor and the fixed contact, the insert extending facing the fixed contact.

The magnetic insert makes it possible to create, as current passes through the fixed contact, a magnetic field which generates, on the mobile contact, a force that tends to oppose the opening of the mobile contact.

According to one exemplary embodiment, the magnetically conducting insert comprises a first portion extending parallel to the bearing surface and extended by a second portion extending perpendicular to the bearing surface toward the first portion of the fixed contact.

The first portion of the magnetically conducting insert has the overall shape of a plate.

The second portion of the magnetically conducting insert has the overall shape of a plate.

The first portion of the fixed contact faces the first portion of the magnetically conducting insert in a direction perpendicular to the bearing surface.

The first portion of the fixed contact faces the second portion of the magnetically conducting insert in a direction parallel to the main direction of extension of the bearing surface.

A distance between the end of the second part of the fixed contact, opposed to the first part in an axial direction, and the second portion of the magnetically conducting insert is comprised between 1% and 10% of the length of the first portion.

The second portion of the magnetically conducting insert may comprise a thinner portion positioned facing the first portion of the fixed contact.

In the closed position, the mobile contact faces the first portion of the magnetically conducting insert in a longitudinal direction of the mobile contact.

In the closed position, the mobile contact faces the second portion of the magnetically conducting insert in a direction transverse to the longitudinal direction of the mobile contact.

A median plane of the fixed contact coincides with a median plane of the magnetically conducting insert.

The magnetically conducting insert is for example made of ferromagnetic steel.

The magnetically conducting insert is for example formed by cutting and bending a metal strip.

According to one embodiment of the electric current switching device, the first portion of the magnetically conducting insert comprises a cutout for the passage of part of the second portion of the fixed contact.

The invention also relates to a medium voltage electrical unit, configured for selectively establishing or cutting off the flow of current in a medium-voltage electrical network comprising three phases, comprising an electric current switching device as described hereinabove installed on each of the phases of the electrical network respectively.

The electrical unit may be a line disconnector or a circuit breaker.

### BRIEF DESCRIPTION OF THE DRAWINGS

Further features, details and advantages will become apparent from reading the detailed description below and from analyzing the appended drawings, in which:

FIG. 1 is a schematic depiction of an electrical unit comprising a switching device, in the position for cutting off the flow of current,

FIG. 2 is a schematic depiction of the electrical unit of FIG. 1 in the position that allows the current to flow,

FIG. 3 is a schematic depiction, in side view, of a switching device according to the invention,

FIG. 4 is a schematic depiction, in side view, of a switching device according to a variant embodiment of the invention,

FIG. 5 is a perspective view of a switching device according to a first embodiment, depicted in the position for cutting off the flow of current,

FIG. 6 is a perspective view of a variant of the switching device of FIG. 5, depicted in the position that allows the current to flow,

FIG. 7 is a perspective view of the fixed contact of the switching device of FIG. 5,

FIG. 8 is another perspective view of the fixed contact of the switching device of FIG. 5,

FIG. 9 is yet another perspective view of the fixed contact of the switching device of FIG. 5,

FIG. 10 is a cross-sectional view of the fixed contact of the switching device of FIG. 5,

FIG. 11 is a partial perspective view of a switching device according to a second embodiment, depicted in the position for cutting off the flow of current,

FIG. 12 is a partial side view of the switching device of FIG. 11,

FIG. 13 is a perspective view of the switching device of FIG. 12, depicted in the position that allows the current to flow.

### Description of the embodiments

In order to make the figures easier to read, the various elements are not necessarily depicted to scale. In these figures, identical elements bear the same reference signs. Certain elements or parameters may be indexed, that is to say designated for example as the first element or the second element, or indeed the first parameter and the second parameter, etc. The aim of this indexing is to differentiate between elements or parameters which are similar but not identical. This indexing does not imply the priority of one element or parameter with respect to another, and the denominations may be interchanged. When it is specified that a device comprises a given element, this does not exclude the presence of other elements in this device. Likewise, when it is specified that a device comprises a given element, it is understood that the device comprises at least this element.

In the various figures, the axes X, Y, Z designate the three directions in space so that the viewpoint for each figure can be identified.

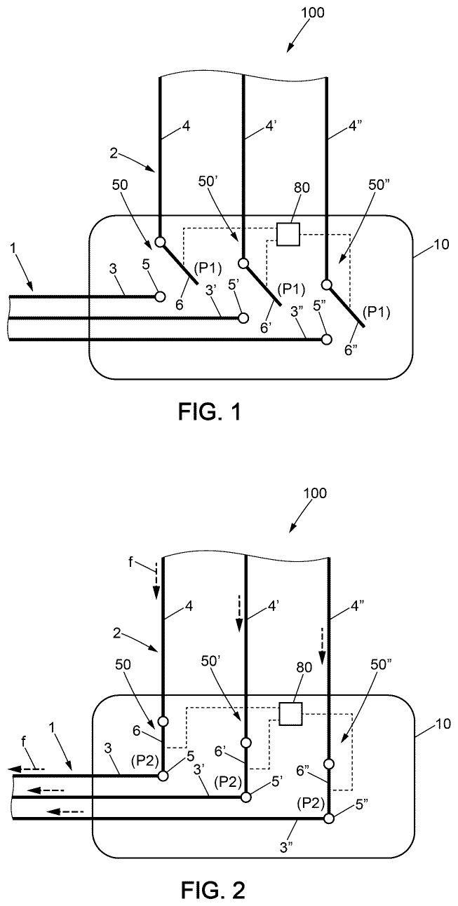

FIG. 1 depicts a medium voltage electrical unit 100, configured for selectively establishing or cutting off the flow of current in a medium-voltage electrical network. The electrical network comprises three phases L1, L2, L3, and comprises an electric current switching device 50, 50′, 50″ installed on each of the phases L1, L2, L3 of the electrical network respectively.

The electrical unit 100 may be a line disconnector or a circuit breaker.

FIG. 1 schematically depicts the electrical unit 100 when each of the electric current switching devices 50, 50′, 50″ is in a position for cutting off the flow of current, preventing electrical current from circulating.

FIG. 2 schematically depicts the electrical unit 100 when each of the electric current switching devices 50, 50′, 50″ is in a position for allowing the flow of current, in which position an electrical current can circulate in the network.

A control device 80 is able to control each of the electric current switching devices 50, 50′, 50″.

One electric current switching device 50 will now be described in detail.

The proposed electric current switching device 50 comprises:
a first electrical line portion 1 comprising a first electrical conductor 3 and a fixed contact 5 secured to the first electrical conductor 3;
a second electrical line portion 2 comprising a second electrical conductor 4 and a mobile contact 6 movable in rotation relative to the second electrical conductor 4.

The mobile contact 6 is configured to be moved between:
a first position P1 referred to as an open position in which the mobile contact 6 is separated from the fixed contact 5 so as to prevent the passage of electrical current between the first electrical line portion 1 and the second electrical line portion 2, and
a second position P2 referred to as a closed position in which the mobile contact 6 is in contact with the fixed contact 5 so as to allow electrical current to pass between the first electrical line portion 1 and the second electrical line portion 2.

The mobile contact 6 extends, in the second position P2, in a direction D6 transverse to a direction of extension D3 of the first electrical conductor 3.

The fixed contact 5 comprises a first portion 11 configured to be in contact with the mobile contact 6 and a second portion 12 fixed to the first electrical conductor 3.

The first portion 11 and the second portion 12 are offset from one another in the direction of extension D3 of the first electrical conductor 3.

The mutual offsetting, in the direction of extension D3 of the first electrical conductor 3, of the first portion 11 and of the second portion 12 makes it possible to soften the change in direction of the electrical current. The electrodynamic forces that have a tendency to open the mobile contact 6, notably when a circuit current is circulating through the electrical line, are thus reduced. The capacity of the switching device 50 is increased, which means to say that the switching device 50 is able to tolerate a higher strength of short-circuit.

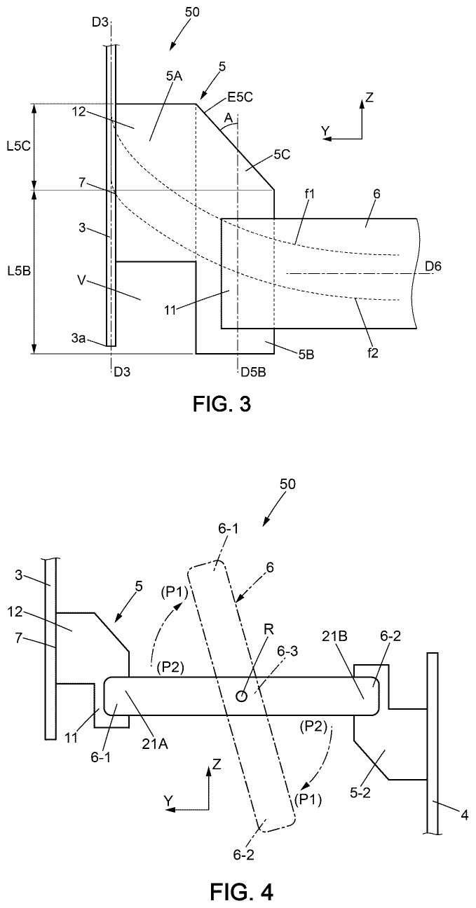

FIG. 3 schematically depicts the circulation of the current between the electrical conductor 3, the fixed contact 5 and the mobile contact 6. The dotted lines indicated by the signs f1, f2 schematically indicate the direction of the electrical current.

Because the electrical current is an alternating current, the first portion 11 may be an input via which the electrical current arrives in the fixed contact 5, and the second portion 12 is then simultaneously an output via which electrical current leaves the fixed contact 5. During another half-period of the alternating current, the circulation of current is reversed. The first portion 11 is then an output via which the electrical current leaves the fixed contact 5, and the second portion 12 is simultaneously an input via which electrical current arrives in the fixed contact 5.

The first electrical conductor 3 comprises, in the example illustrated, an electric current conductor rod.

Likewise, the second electrical conductor 4 here comprises an electric current conductor rod.

The first electrical conductor 3 is secured to a frame 10.

The second electrical conductor 4 is secured to the frame 10.

The frame 10, which is rigid, forms a structure to which to fix the various components of the electrical unit 100.

The first electrical conductor 3 is for example formed by a rod, for example a copper rod. Likewise, the second electrical conductor 4 may also be formed by a copper rod.

Each rod may have a cross section of rectangular shape.

The first electrical conductor 3 is thus rigid. The second electrical conductor 4 is also rigid.

The fixed contact 5 is rigidly connected to the frame 10.

The mobile contact 6 is movable in rotation with respect to the frame.

According to one exemplary embodiment, the mobile contact 6 has the form of a rod, for example a rectilinear rod.

What is meant by the fact that the mobile content 6 extends, in the second position P2, in a direction D6 transverse to a direction of extension D3 of the first electrical conductor 3, is that the angle B between the direction of extension D6 of the mobile contact 6 and the direction of extension D3 of the first electrical conductor 3 is comprised between 60° and 90°.

According to one embodiment, the mobile contact 6 is articulated at a first end 6-1. At its second end 6-2 opposite to the first end 6-1 the mobile contact 6 comprises a contact zone 21. The contact zone 21 is configured to establish electrical contact with the fixed contact 5 of the first electrical conductor 3 when the mobile contact 6 is in the second position P2 referred to as a closed position.

In this embodiment, the mobile contact 6 establishes permanent electrical contact with the second electrical conductor 4 at the articulation.

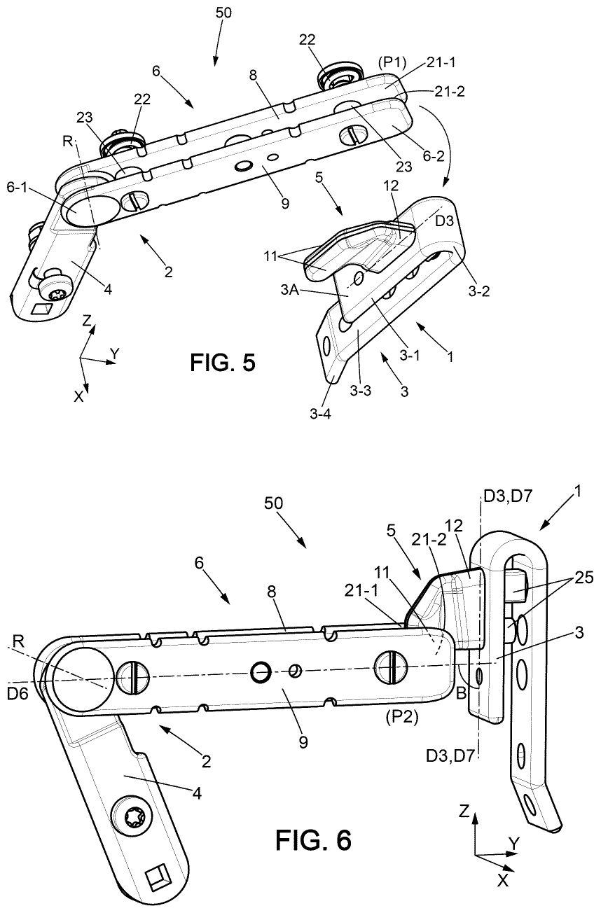

This type of mobile contact is depicted in FIGS. 5, 6, 7 and in FIG. 12.

According to another embodiment, illustrated schematically in FIG. 4, the mobile contact 6 is articulated at a middle part 6-3 situated between the first end 6-1 and the second end 6-2. The sign R′ indicates the axis of rotation.

The mobile contact 6 comprises, at a first end 6-1, a first contact zone 21A configured to establish electrical contact with the fixed contact 5 of the first electrical conductor 3 when the mobile contact 6 is in the second position P2 referred to as a closed position.

The mobile contact 6 comprises, at its second end 6-2, a second contact zone 21B configured to establish electrical contact with the second electrical conductor 4 when the mobile contact 6 is in the second position P2 referred to as a closed position.

In other words, in this embodiment, the second electrical conductor 4 itself comprises a fixed contact 5-2 that can be selectively separated from the mobile contact 6 or engaged with the mobile contact 6.

Rotating the mobile contact 6 makes it possible to establish mechanical and electrical contact between the mobile contact 6 and each of the first and second electrical conductors 3, 4.

In the first position P1 referred to as an open position, the mobile contact 6 is separated both from the fixed contact 5 of the first electrical conductor 3 and from the fixed contact 5′ of the second electrical conductor 4.

The particular shape proposed for the fixed contact 5 may be applied to an electric current switching device in which the mobile contact is articulated at one end, just as well as it may be applied to an electric current switching device in which the mobile contact is articulated at its middle.

At least part of the first portion 11 is separated from the first electrical conductor 3 by a portion V devoid of material.

In other words, at least part of the first portion 11 is separated from the first electrical conductor 3 by a gas void.

The gas is the gas surrounding the electric current switching device 50, namely the gas contained inside the frame 10 of the electrical unit 100.

The gas may for example be air or some other gas having good electrical insulation properties, such as sulphur hexafluoride. (chemical formula SF₆)

The fixed contact 5 comprises a bearing face 7 configured to be in contact with the first electrical conductor 3, and the first portion 11 is connected to the bearing face 7 by a portion of material having a concave shape.

Certain straight-line segments joining the first portion 11 to the bearing face 7 are thus not contained inside the volume delimited by the exterior surface of the fixed contact 5. In other words, these straight-line segments connecting the first portion 11 to the bearing face 7 extend outside of the material of which the fixed contact 5 is formed.

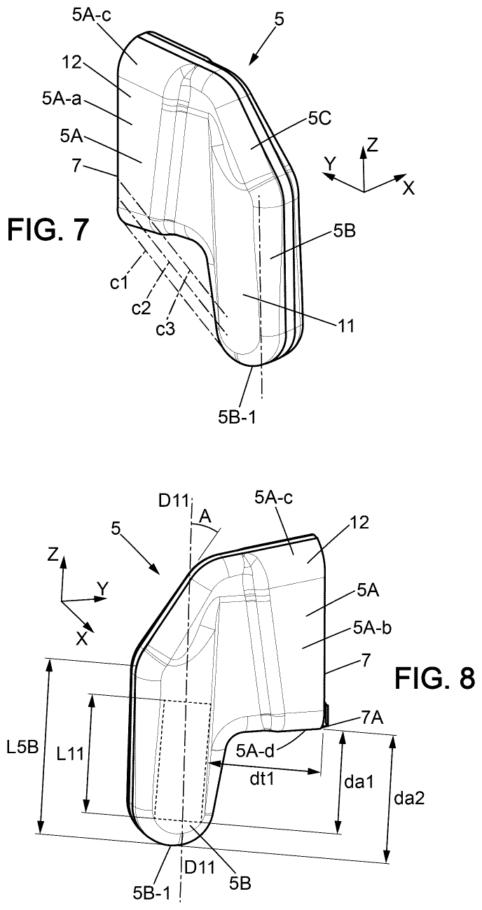

In FIG. 7, the segments c1, c2, c3 illustrate the concave-shaped portion of the fixed contact 5.

In the example illustrated, the first portion 11 and the second portion 12 partially overlap in the direction of extension D3 of the first electrical conductor.

The direction of extension D3 of the first electrical conductor 3 is the direction in the vicinity of the fixed contact 5.

What that means to say is that the direction of extension D3 of the first electrical conductor 3 is the direction in the immediate vicinity of the junction between the fixed contact 5 and the first electrical conductor 3.

The direction of extension D3 of the first electrical conductor 3 is thus coincident with the main direction of extension D7 of the bearing face 7.

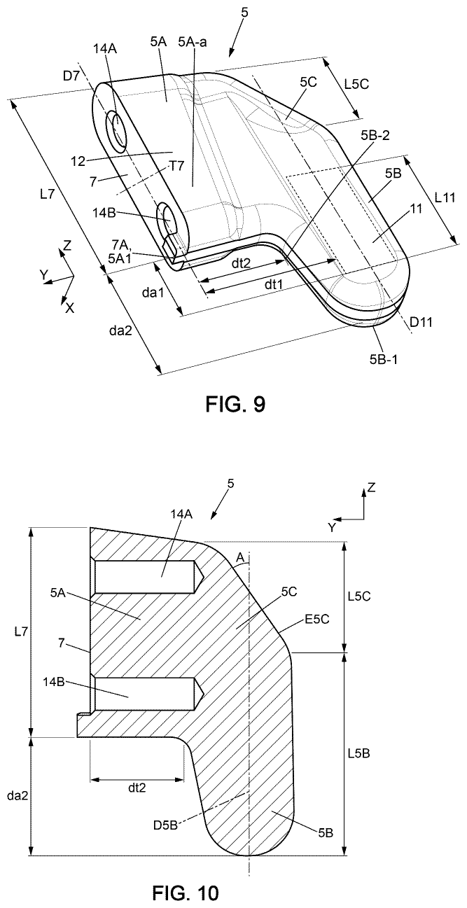

What is meant by the main direction of extension is the axis of the longest dimension of the bearing face 7. This then is the direction corresponding to the length of the bearing face 7. This main direction of extension is particularly visible in FIG. 9.

The direction of extension D3 of the first electrical conductor 3 coincides with the main direction of extension D7 of the bearing face 7 in the vicinity of the fixed contact 5.

In this figure, the sign T7 indicates the direction transverse to the direction D7. This transverse direction corresponds to the width of the bearing face 7.

The shape of the first electrical conductor 3 may evolve along its length, or in other words, the first electrical conductor 3 is not necessarily rectilinear over its entire length.

In the example depicted, the first electrical conductor 3 has a U-shaped portion. The first electrical conductor 3 comprises a first rectilinear portion 3-1, extended by a curved portion 3-2, itself extended by a second rectilinear portion 3-3. The second rectilinear portion 3-3 and the first rectilinear portion 3-1 extend in parallel planes and face one another.

The second rectilinear portion 3-3 is extended by a third portion 3-4 that makes an angle with the second rectilinear portion 3-3. The third portion 3-4 may be connected to another electrical conductor, not depicted, that forms part of the electrical line of the medium-voltage electrical unit 100.

According to the embodiment illustrated in FIG. 5, the first portion 11 of the fixed contact 5 faces an end portion 3A of the first electrical conductor 3.

According to one embodiment of the electric current switching device 50, the mobile contact 6 comprises two electrically conducting and mechanically connecting blades 8, 9, the two blades 8,9 being parallel to one another and distant from one another, and
the fixed contact 5 is in contact with each of the blades 8, 9 when the mobile contact 6 is in the second position P2.

The first portion 11 is positioned between the blades 8, 9 when the mobile contact 6 is in the second position P2.

In FIG. 5, the mobile contact 6 is in an open position P1. The first blade 8 comprises a contact zone 21-1 and the second blade 9 comprises a contact zone 21-2.

The contact zone 21-1 of the first blade 8 and the contact zone 21-2 of the second blade 9 face one another.

The two blades 8, 9 are rotationally connected and may pivot simultaneously about the axis of rotation R. Two springs 22 apply to the first blade 8 a force that tends to move the first blade 8 closer to the second blade 9 in a direction parallel to the axis of rotation R.

Two spacers 23 act as a stop in order to keep the blades apart from one another when the mobile contact 6 is in an open position P1, as in FIG. 5.

In FIG. 6, the mobile contact 6 is in a closed position P2.

Part of the fixed contact 5 is positioned between the two blades 8, 9.

The contact zone 21-1 of the first blade 8 is in contact with one face of the first portion 11 of the fixed contact 5, and the contact zone 21-2 of the second blade 9 is in contact with an opposite face of the first portion 11 of the fixed contact 5.

The springs 22 ensure that there is sufficient contact pressure between the blades 8, 9 and the fixed contact 5.

The proposed fixed contact 5 may have specific dimensions.

According to the example illustrated, in which the fixed contact 5 comprises a bearing face 7 configured to be in contact with the first electrical conductor 3, a distance da1 between an end of the first portion 11 of the fixed contact 5, directed away from the bearing face 7 in an axial direction, and an end 7A of the bearing face 7 situated facing the first portion 11, the distance da1 being measured parallel to the main direction of extension D7 of the bearing face 7, is comprised between 50% and 100% of a length L11 of the first portion 11, the length L11 being measured parallel to a direction of extension D11 of the first portion 11.

According to the example illustrated, in which the fixed contact 5 comprises a bearing face 7 configured to be in contact with the first electrical conductor 3, a distance da1 between an end of the first portion 11 of the fixed contact 5, opposed to the bearing face 7 in an axial direction, and an end of the bearing face 7 situated facing the first portion 11, the distance da1 being measured parallel to the main direction of extension D7 of the bearing face 7, is comprised between 100% and 300% of a distance dt1 between the first portion 11 and the bearing face 7, the distance dt1 being measured parallel to a direction perpendicular to the bearing face 7.

These various dimensions are particularly illustrated in FIGS. 8 and 9. These values of offset make it possible to reduce the electrodynamic forces on the mobile contact 6 while at the same time keeping the mechanical strength of the fixed contact 5 sufficiently high.

According to one embodiment of the electric current switching device 50, the fixed contact 5 comprises:
a first part 5A of parallelepipedal overall shape, comprising a bearing face 7 configured to be in contact with the first electrical conductor 3,
a second part 5B of cylindrical overall shape extending the first part 5A in a direction perpendicular to the bearing face 7,
the second part 5B being offset from the bearing face 7 in a main direction of extension D7 of the bearing face 7,
and the first portion 11 of the fixed contact 5 is formed by a portion of a peripheral surface of the second part 5B.

The main direction of extension D7 of the bearing face 7 and the axis D5B of the second part 5B are parallel.

The main direction of extension D7 of the bearing face 7 and the axis D5B of the second part 5B define a plane perpendicular to the axis of rotation R of the mobile contact 6.

What is meant by the first part 5A having a parallelepipedal overall shape is that it comprises two planar and substantially parallel opposite faces 5A-a, 5A-b. These two planar faces 5A-a, 5A-b are respectively joined to one another at each of their ends by two portions 5A-c, 5A-d. The two portions 5A-c, 5A-d each comprise two rounded portions connected by a planar zone.

According to the embodiment illustrated, the second part 5B of the fixed contact 5 is extended, in an axial direction, by a third part 5C that is inclined towards the first part 5A of the fixed contact 5.

The inclined part 5C of the fixed contact plays a part in reducing the electrodynamic forces on the mobile contact 6, and thus in further reducing the tendency of the contacts 5, 6 to separate, notably in the event of a short-circuit.

In cross section on a plane passing through the main direction of extension D7 of the bearing face 7 and perpendicular to the bearing face 7, an exterior periphery E5C of the third part 5C makes an angle A of between 30° and 50° with a direction of extension D5B of the second part 5B.

This angle A is illustrated in FIGS. 3, 8 and 10.

According to the example illustrated, an end 5B-1 of the second part 5B of the fixed contact 5, the opposite end from the first part 5A in an axial direction, has a substantially hemispherical shape.

In other words, the second part 5B, of cylindrical overall shape, is terminated at one end by a rounded portion of a shape close to that of a hemisphere. At the other end in an axial direction, the second part 5B is connected to the third part 5C. In a radial direction, the second part 5B is connected to the first part 5A.

The first part 5A, of parallelepipedal overall shape, the second part 5B, of cylindrical overall shape, and the inclined third part 5C may have specific dimensions.

A distance da2 between an end 5B-1 of the second part 5B of the fixed contact 5, opposed to the first part 5A in an axial direction, and an end 5A-1 of the first part 5A of the fixed contact 5, which is situated facing the second part 5B, the distance da2 being measured parallel to the main direction of extension D7 of the bearing face 7, is comprised between 50% and 100% of a length L5B of the second part 5B of the fixed contact 5, the length L5B being measured parallel to the axis of extension D5B of the second part 5B.

In addition a distance da2 between an end 5B-1 of the second part 5B of the fixed contact 5, opposed to the first part 5A in an axial direction, and an end 5A-1 of the first part 5A of the fixed contact 5, which is situated facing the second part 5B, the distance da2 being measured parallel to the main direction of extension D7 of the bearing face 7, is comprised between 50% and 100% of a length L7 of the bearing face 7 of the first part 11 of the fixed contact 5, the length L7 being measured parallel to the main direction of extension D7 of the bearing face 7.

A length L5C of the third part 5C is comprised between 5% and 100% of a length L7 of the bearing face 7 of the first part 11 of the fixed contact 5, the length L5C of the third part 5C and the length L7 being measured parallel to the main direction of extension D7 of the bearing face 7.

A distance dt2 between a proximal edge 5B-2 of the second part 5B of the fixed contact 5, facing toward the bearing face 7, and the bearing face 7, the distance being measured in a direction perpendicular to the bearing face 7, is comprised between 20% and 100% of a length L5B of the second part 5B of the fixed contact 5, the length L5B being measured parallel to the axis of extension of the second part 5B.

These dimensions are illustrated in FIGS. 8, 9 and 10. As stated previously, these dimensions make it possible to reduce the electrodynamic forces on the mobile contact 6 while at the same time keeping the mechanical strength of the fixed contact 5 sufficiently high.

The fixed contact 5 forms, for example, a one-piece entity.

The fixed contact 5 is for example made of copper.

According to a variant embodiment which has not been illustrated, the fixed contact 5 may be formed from an assembly of several components.

The first part 5A comprises two threaded bores 14A, 14B opening into the bearing face 7, each threaded bore 14A, 14B being configured to accept a respective fixing screw 25 for fixing to the first electrical conductor 3.

The fixed contact 5 is for example solid, which means to say that the fixed contact 5 has no internal cavity with the exception of the threaded bores that enable it to be fixed to the first electrical conductor 3.

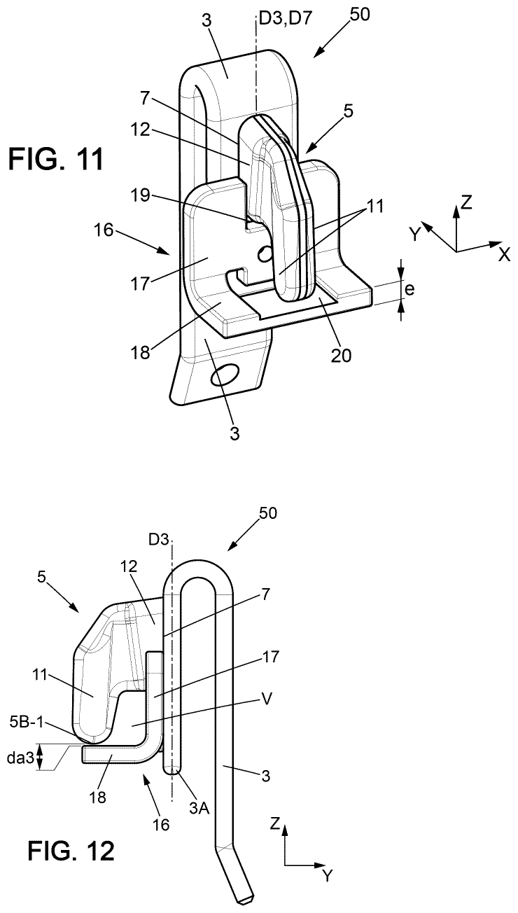

FIGS. 11, 12, 13 illustrate a second embodiment in which an additional element has been added.

According to this second embodiment, the electric current switching device 50 comprises a magnetically conducting insert 16 arranged in part between the first electrical conductor 3 and the fixed contact 5, the insert 16 extending facing the fixed contact 5.

The magnetic insert 16 makes it possible to create, as electric current passes through the fixed contact 5 and the mobile contact 6, a magnetic field which generates, on the mobile contact 6, a force that tends to oppose the opening of the mobile contact 6.

FIGS. 11 and 12 show the magnetic insert 16 when the mobile contact 6 is in an open position. It is therefore not visible in these two figures.

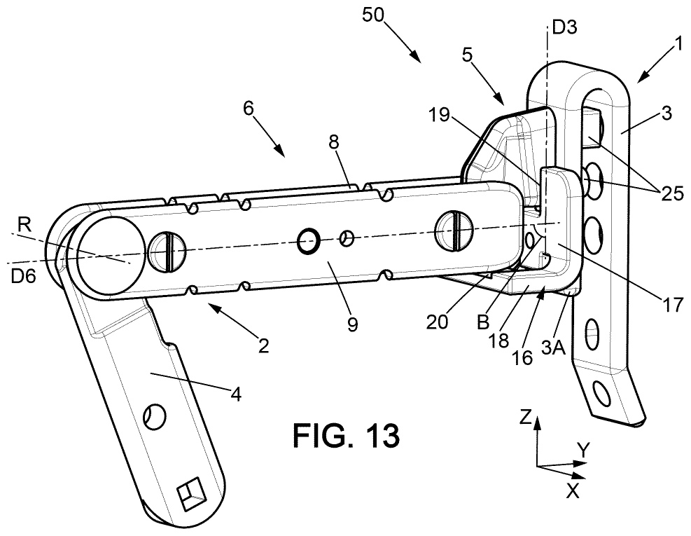

FIG. 13 shows the magnetic insert 16 when the mobile contact 6 is in a closed position P2.

As illustrated notably in FIG. 11, the magnetically conducting insert 16 comprises a first portion 17 extending parallel to the bearing surface 7 and extended by a second portion 18 extending perpendicular to the bearing surface 7 toward the first portion 11 of the fixed contact 5.

The first portion 17 of the magnetically conducting insert 16 has the overall shape of a plate.

The second portion 18 of the magnetically conducting insert 16 has the overall shape of a plate.

The first portion 11 of the fixed contact 5 faces the first portion 17 of the magnetically conducting insert 16 in a direction perpendicular to the bearing surface 7. The first portion 11 of the fixed contact 5 faces the second portion 18 of the magnetically conducting insert 16 in a direction parallel to the main direction of extension D7 of the bearing surface 7.

As indicated in FIG. 12, a distance da3 between the end 5B-1 of the second part 5B of the fixed contact 5 that is opposed to the first part 5A in an axial direction, and the second portion 18 of the magnetically conducting insert 16 is comprised between 1% and 10% of the length L11 of the first portion 11.

The second portion 18 of the magnetically conducting insert 16 may comprise a thinner portion 20 positioned facing the first portion 11 of the fixed contact 5. The thinner portion 20 is depicted in FIGS. 11 and 13.

In the closed position P2, the mobile contact 6 faces the first portion 17 of the magnetically conducting insert 16 in a longitudinal direction D6 of the mobile contact 6. In the closed position P2, the mobile contact 6 faces the second portion 18 of the magnetically conducting insert 16 in a direction transverse to the longitudinal direction of the mobile contact 6.

A median plane of the fixed contact 5 coincides with a median plane of the magnetically conducting insert 16.

The magnetically conducting insert 16 is for example made of ferromagnetic steel. The magnetically conducting insert 16 is for example formed by cutting and bending a metal strip.

The thickness e of the metal strip is for example comprised between 1 millimetre and 10 millimetres.

According to the example illustrated, the first portion 17 of the magnetically conducting insert 16 comprises a cutout 19 for the passage of part of the second portion 12 of the fixed contact 5.

The cutout of the first portion 17 defines three consecutive facets of a rectangle.

The three facets surround the second portion 12 of the fixed contact 5. There is a clearance between each facet and the second portion 12 of the fixed contact 5.

The electric current switching devices 50, 50′, 50″ of the electrical unit 100 may be identical.

The switching devices 50′, 50″ respectively comprise a mobile contact 6′, 6″ making it possible selectively to establish or interrupt the flow of current between a first electrical conductor 3′, 3″ and a second electrical conductor 4′, 4″. The first electrical conductor 3′, 3″ comprises a fixed contact 5′, 5″.

1. An electric current switching device, comprising:
a first electrical line portion comprising a first electrical conductor and a fixed contact secured to the first electrical conductor;
a second electrical line portion comprising a second electrical conductor and a mobile contact movable in rotation relative to the second electrical conductor,
the mobile contact being configured to be moved between:
a first position referred to as an open position in which the mobile contact is separated from the fixed contact so as to prevent the passage of electrical current between the first electrical line portion and the second electrical line portion, and
a second position referred to as a closed position in which the mobile contact is in contact with the fixed contact so as to allow electrical current to pass between the first electrical line portion and the second electrical line portion,
wherein the mobile contact extends, in the second position, in a direction transverse to a direction of extension of the first electrical conductor,
wherein the fixed contact comprises a first portion configured to be in contact with the mobile contact and a second portion fixed to the first electrical conductor,
and wherein the first portion and the second portion are offset from one another in the direction of extension of the first electrical conductor.

2. The electric current switching device according to claim 1, wherein the first portion of the fixed contact faces an end portion of the first electrical conductor.

3. The electric current switching device according to claim 1, wherein the fixed contact comprises a bearing face configured to be in contact with the first electrical conductor, and wherein the first portion is connected to the bearing face by a portion of material having a concave shape.

4. The electric current switching device according to claim 1, wherein the mobile contact comprises two electrically conducting and mechanically connecting blades, the two blades being parallel to one another and distant from one another,
wherein the fixed contact is in contact with each of the blades when the mobile contact is in the second position.

5. The electric current switching device according to claim 1, wherein the fixed contact comprises a bearing face configured to be in contact with the first electrical conductor, and wherein a distance between an end of the first portion of the fixed contact, directed away from the bearing face in an axial direction, and an end of the bearing face situated facing the first portion, the distance being measured parallel to the main direction of extension of the bearing face, is comprised between 50% and 100% of a length of the first portion, the length being measured parallel to a direction of extension of the first portion.

6. The electric current switching device according to claim 1, wherein the fixed contact comprises a bearing face configured to be in contact with the first electrical conductor,
and wherein a distance between an end of the first portion of the fixed contact, opposed to the bearing face in an axial direction, and an end of the bearing face situated facing the first portion, the distance being measured parallel to the main direction of extension of the bearing face, is comprised between 100% and 300% of a distance between the first portion and the bearing face, the distance being measured parallel to a direction perpendicular to the bearing face.

7. The electric current switching device according to claim 1, wherein the fixed contact comprises:
a first part of parallelepipedal overall shape, comprising a bearing face configured to be in contact with the first electrical conductor,
a second part of cylindrical overall shape extending the first part in a direction perpendicular to the bearing face,
the second part being offset from the bearing face in a main direction of extension of the bearing face,
wherein the first portion of the fixed contact is formed by a portion of a peripheral surface of the second part.

8. The electric current switching device according to claim 7, wherein the second part of the fixed contact is extended, in an axial direction, by a third part that is inclined towards the first part of the fixed contact.

9. The electric current switching device according to claim 8, wherein, in cross section on a plane passing through the main direction of extension of the bearing face and perpendicular to the bearing face, an exterior periphery of the third part makes an angle of between 30° and 50° with a direction of extension of the second part.

10. The electric current switching device according to claim 7, wherein an end of the second part of the fixed contact, opposed to the first part in an axial direction, has a substantially hemispherical shape.

11. The electric current switching device according to claim 7, wherein a distance between an end of the second part of the fixed contact, opposed to the first part in an axial direction, and an end of the first part of the fixed contact, which is situated facing the second part, the distance being measured parallel to the main direction of extension of the bearing face, is comprised between 50% and 100% of a length of the second part of the fixed contact, the length being measured parallel to the axis of extension of the second part.

12. The electric current switching device according to claim 7, wherein a distance between an end of the second part of the fixed contact, opposed to the first part in an axial direction, and an end of the first part of the fixed contact, which is situated facing the second part, the distance being measured parallel to the main direction of extension of the bearing face, is comprised between 50% and 100% of a length of the bearing face of the first part of the fixed contact, the length being measured parallel to the main direction of extension of the bearing face.

13. The electric current switching device according to claim 8, wherein a length of the third part is comprised between 5% and 100% of a length of the bearing face of the first part of the fixed contact, the length of the third part and the length being measured parallel to the main direction of extension of the bearing face.

14. The electric current switching device according to claim 7, wherein a distance between a proximal edge of the second part of the fixed contact, facing toward the bearing face, and the bearing face, the distance being measured in a direction perpendicular to the bearing face, is comprised between 20% and 100% of a length of the second part of the fixed contact, the length being measured parallel to the axis of extension of the second part.

15. The electric current switching device according to claim 1, comprising a magnetically conducting insert arranged in part between the first electrical conductor and the fixed contact, the insert extending facing the fixed contact.

16. The electric current switching device according to claim 15, wherein the magnetically conducting insert comprises a first portion extending parallel to the bearing surface and extended by a second portion extending perpendicular to the bearing surface toward the first portion of the fixed contact.

17. The electric current switching device according to claim 16, wherein the first portion of the magnetically conducting insert comprises a cutout for the passage of part of the second portion of the fixed contact.

18. A medium voltage electrical unit, configured for selectively establishing or cutting off the flow of current in a medium-voltage electrical network comprising three phases, comprising an electric current switching device according to claim 1 installed on each of the phases of the electrical network respectively.
